(19) United States
(12) Patent Application Publication
(10) Pub. No.: US 2024/0217020 A1
(43) Pub. Date: Jul. 4, 2024

(54) Combined Extraction/Shielding Gas Nozzle of an Arc Welding Torch with a Consumable Electrode and Torch Neck Having a Combined Extraction/Shielding Gas Nozzle

(71) Applicant: Alexander Binzel Schweisstechnik GmbH & Co. KG, Buseck (DE)

(72) Inventors: Sascha Rose, Fernwald (DE); Jannik Muzika, Mornshausen (DE)

(73) Assignee: Alexander Binzel Schweisstechnik GmbH & Co. KG, Buseck (DE)

(21) Appl. No.: 18/558,389

(22) PCT Filed: Mar. 15, 2022
(86) PCT No.: PCT/EP2022/056709

§ 371 Date: Nov. 1, 2023

(30) Foreign Application Priority Data
May 6, 2021 (DE) 102021111790.9

(51) Int. Cl. B23K 9/173; B23K 9/29; B23K 9/32

(52) U.S. Cl. CPC B23K 9/173; B23K 9/291; B23K 9/325

(57) ABSTRACT

A combined extraction/shielding gas nozzle (10) of an arc welding torch with a consumable electrode has a shielding gas channel (1) for supplying shielding gas to the welding process and has an extraction device (3) with at least one extraction channel (6) with an extraction opening (7) for extracting the flue gas produced during the welding process. The shielding gas channel (1) and the at least one extraction channel (6) are disposed radially and offset to one another in the axial direction such that the extraction opening (7) for the at least one extraction channel (6) lies behind the shielding gas channel (1) in the direction of flow of the flue gas.

### CROSS-REFERENCE TO RELATED APPLICATIONS

This application is a national stage application (under 35 USC § 371) of PCT/EP2022/056709, filed Mar. 15, 2022, which claims benefit of DE 102021111790.9, filed May 6, 2021, the contents of each of which is incorporated by reference herein.

### BACKGROUND OF THE INVENTION

### Technical Field and State of the Art

The invention relates to a combined extraction/shielding gas nozzle of an arc welding torch with a consumable electrode and a torch neck for thermally joining at least one workpiece, in particular for arc welding.

Thermal arc joining methods use energy to melt and join workpieces. “MIG”, “MAG”, and “WIG” welding are routinely used for sheet metal fabrication.

In inert gas-supported arc welding methods with melting electrode (MSG), “MIG” is short for “Metal Inert Gas”, and “MAG” is short for “Metal Active Gas”. In inert gas-supported arc welding methods with non-melting electrode (WSG), “TIG” is short for “Tungsten Inert Gas”. The welding apparatuses according to the invention can be configured as machine-guided torches.

MAG welding is a metal inert gas welding process (MSG) with active gas in which the arc burns between a continuously supplied, consumable wire electrode and the material. The melting electrode supplies the filler material to form the weld seam. MAG welding can be used easily and economically for almost all materials suitable for welding. Depending on the requirements and materials, different shielding gases are used.

During MSG welding, the active gas supplied protects the electrode, the arc, and the weld pool from the atmosphere. This ensures good welding results with high deposition rates under a wide range of conditions. Depending on the material, a gas mixture of argon CO2, argon O2, or pure argon or pure CO2 is used as the shielding gas. Depending on the requirements, different wire electrodes are used. MAG welding is a robust, economical, and versatile welding process that is suitable for manual, mechanical, and automated processes.

MAG welding is suitable for welding unalloyed or low-alloy steels. In principle, high-alloy steels and nickel-based alloys can also be welded using the MAG process. However, the O2 or CO2 content in the shielding gas is low. Depending on the requirements for the weld seam and the optimal welding result, different types of arcs and welding processes, such as the standard or pulse process, are used.

To melt the weld metal, arc welding apparatuses generate an arc between the workpiece and a melting or non-melting welding electrode. The weld metal and the welding point are shielded from the atmospheric gases, mainly N2, O2, H2, in the ambient air, by a shielding gas stream.

The torch neck typically accommodates a group of interior welding current guiding components that guide the welding current from a welding current source in the arc welding unit to the tip of the torch head onto the welding electrode, in order to then generate the arc from there to the workpiece.

The stream of shielding gas flows around the welding electrode, the arc, the weld pool, and the heat-affected zone on the workpiece, and is then fed to these regions by the torch neck of the torch. A gas nozzle guides the stream of shielding gas to the front end of the torch, where the stream of shielding gas exits from the torch head approximately annularly about the welding electrode.

In the prior art, the gas is guided to the gas nozzle usually via components made of a material with low electrical conductivity (polymers or oxide ceramics), which can also serve as insulation.

During the welding operation, the arc generated for welding heats up the workpiece to be welded and the fed weld metal, if any, such that these are melted. The arc energy input, the high-energy heat radiation, and convection result in a significant heat input into the torch head of the welding torch. Part of the heat introduced can be dissipated again through the shielding gas flow conducted through the torch head or through passive cooling in the ambient air and heat conduction into the tube package.

However, above a certain welding current load on the torch head, the heat input is so great that so-called active cooling of the torch head is required in order to protect the components used against thermal material failure. For this purpose, the torch head is actively cooled with a coolant, which flows through the torch head and removes the unwanted heat absorbed from the welding process. For example, deionized water with added ethanol or propanol for the purpose of antifreeze can be used as a coolant.

In addition to welding, brazing is another alternative for joining sheet metal components. Differently than welding, brazing does not involve melting the workpiece, but only the filler material. The reason for this is that brazing joins two edges with the weld metal as the filler material. The melting temperatures of the weld metal and the component materials lie far part, which is why only the weld metal melts during the operation.

Argon I1 or Ar mixtures with admixtures of CO2, O2, or H2 in accordance with DIN ISO 14175 can typically be used for arc soldering.

In terms of equipment, the principle of MSG arc soldering is largely identical to MSG welding with wire-shaped filler material.

From EP 2 407 267 B1 and EP 2 407 268 B1, a welding torch is known, having a shielding gas supply, a torch connection block, a torch neck adjoining the torch connection block at one end, and a torch head provided at the other end of the torch neck, wherein the torch neck comprises an inner tube, an outer tube, and an insulating tube provided between the inner tube and the outer tube.

Such welding torches are used in the prior art, among other things, for metal inert gas welding (MIG). For example, such a welding torch is described in the publication DE 10 2004 008 609 A1. With this welding torch, the welding current is supplied to the welding wire located in the inner tube via the contact nozzle. The outer parts of the torch are electrically insulated from the inner tube in order to prevent welding currents from flowing across the torch housing. During the welding process, the welding wire is heated, and some of the heat is conducted into the welding torch.

In general, the shielding gas used in the welding process can be used as effectively as possible in order to cool the inner tube. Effective cooling of the inner tube can be achieved when the gas flows along the outside of the inner tube in planar channels. In order to create gas flow channels on the outside of the inner tube, a casing tube is used on the inner tube in the prior art. The composite consisting of inner tube and casing tube is then insulated from an outer housing tube by an insulating tube.

The shielding gas is initially supplied through the shielding gas supply, which is typically designed in the form of a hole in the torch connection block. Because the shielding gas can be supplied asymmetrically to the inner tube, the shielding gas should be distributed as evenly as possible around the inner tube. For this purpose, it is proposed, for example in EP 2 407 267 B1, that the outer annular channel be formed within the torch connection block and around the inner tube, through which the shielding gas can be distributed around the inner tube. The shielding gas thus flows from the bore in the torch connection block via the outer annular channel and the radial gas channels to the space between the inner tube and the insulating tube or, if necessary, also to the space between the insulating tube and the outer tube.

To capture the flue gases and pollutants produced during welding as close as possible to the point of origin, i.e., the welding process, torches with extraction devices are provided.

EP 2 298 485 A1 discloses a torch with an extraction housing, which encloses the torch neck in a relatively short section. An extraction tube is connected to the extraction housing and is laid parallel to the remaining section of the torch neck and to the handle with the torch tube package.

EP 0 835 711 A2 relates to a welding torch with an extraction tube that surrounds the torch neck and forms a flue gas channel in the intermediate space. The extraction tube merges into an extraction nozzle in the front region. The flue gas is extracted directly at the welding point. The extraction tube is firmly connected to the torch neck using a triple bar and a union nut. At the handle-side end, the extraction tube opens into a bypass-like extraction tube outside next to the handle of the torch.

An electric welding torch with a flue gas extraction device is known from EP 3 804 898 A1.

WO 2009/050 637 A1 relates to a welding torch. The welding fumes are sucked into a plurality of flue exhaust openings and discharged through the torch cable.

EP 2 561 944 A1 describes a welding torch with a flue gas sensor.

AT 413 668 B relates to a gas nozzle for a welding torch, which consists of copper or a copper alloy, and a welding torch which comprises a gas nozzle, a nozzle assembly, and a contact tube, wherein the gas nozzle and/or the nozzle assembly and/or the contact tube are made of copper or a copper alloy.

A disadvantage of the known device is that the handling of the torch is restricted by the extraction device disposed on the torch head because the flue gas extracted via the extraction nozzle is guided parallel to the handle of the torch via a separate bypass line. In addition, by conducting the flue gas via this line, which runs parallel to the torch neck, the extracted volume flow is severely limited.

In addition, it is disadvantageous that, in the known devices, welding can also be carried out without an extraction nozzle, so that the harmful flue gases and pollutants are consequently not extracted and can be inhaled by a user, which poses a major health risk.

Based on the disadvantages described above, the invention addresses the problem of providing an improved nozzle unit and an improved torch neck, which have a reduced weight and size and ensure safe and simple operation. The size and weight should differ as little as possible from a conventional welding torch.

Furthermore, the challenge in the design of welding fume extraction torches is to be able to generate a sufficient extraction volume flow with a limited extraction power, in order to achieve sufficient capture of the welding fumes and not adversely affect the shielding gas flow.

### SUMMARY OF THE INVENTION

The invention relates to a combined extraction/shielding gas nozzle of an arc welding torch with a consumable electrode, such as a MIG torch, with a shielding gas channel for supplying shielding gas to the welding process and an extraction device with at least one extraction channel with an extraction opening for extracting the flue gas or pollutants produced during the welding process.

According to one embodiment of the invention, the shielding gas channel and at least one extraction channel are disposed radially and offset to one another in the axial direction such that the extraction opening for at least one extraction channel lies behind the shielding gas channel in the direction of flow of the flue gas.

In this way, an extraction shielding gas nozzle for MIG torches that is as compact as possible is realized. Furthermore, optimal smoke extraction is implemented in order to protect welders and operators from welding fumes. In such a configuration, the harmful emissions are still extracted close enough to the point of origin, i.e., the welding process, so that welders and operators do not come into contact with the welding fumes. The aim is in particular to reach the induced speed of the extraction flow according to EN ISO 21904-1, which describes a flow speed calculated from the volume flow at the virtual arc approach at the end of the wire.

In addition, it is particularly advantageous that the extraction openings of the extraction device are disposed axially offset from the shielding gas outlet of the nozzle in relation to the longitudinal axis of the nozzle. The flue gas is guided via the combined extraction/shielding gas nozzle, although in this case, by contrast to the prior art, no change to the torch head is required. The conduction of the flue gas coaxially to the actual torch neck is easy to implement. It does not require a bypass and, above all, it does not require any modification to the torch neck itself.

This orientation (outward and less forward) is particularly important for the extraction of ozone as a gaseous pollutant, which is only created at some distance from the process, induced by the arc radiation. Here, the invention creates a greater degree of freedom in that the extraction section, i.e., the extraction openings, are disposed further rearward and aligned outward. This solution is especially suitable for limited current strengths of up to 300 A, and correspondingly less directed arc currents, in order to achieve very good extraction results.

A further advantage of the embodiment according to the invention is that the extraction of the flue gas and the supply of the shielding gas take place one after the other in the flow direction, i.e., shielding gas flows out at the front end of the nozzle and the extraction only takes place behind it, when viewed in the flue gas extraction direction. This helps to largely avoid heating of the shielding gas due to hot flue gases, and the arrangement of the extraction openings also prevents them from heating up additionally on the hot shielding gas nozzle surface, which can lead to increased temperatures in the torch, especially in the handle.

As mentioned above, it is disadvantageous in the prior art that the flue gas extracted via a nozzle on the torch head is conducted into the handle via a tube in the manner of a bypass and is discharged from there via the tube package. This means that the handling of the torch is greatly restricted.

By contrast, the invention proposes that the extraction device be attached to the handle of the torch. While in the prior art, the nozzle is fixed on the torch head, in the invention the flue gas is discharged via the torch head and conduction takes place on the torch neck into the handle and not via a separate bypass line. In the invention, the flue gas is guided from the nozzle on the torch head via the torch neck of the nozzle to the handle.

According to a first advantageous development of the invention, the shielding gas channel and the extraction channel are aligned substantially axially parallel to one another. The flue gas therefore flows in the nozzle in the opposite direction compared to the shielding gas. This configuration results in a particularly compact design of the nozzle. Preferably, the shielding gas channel and extraction channel can be disposed centrally in relation to one another. This can be the case, in particular, when only a single extraction channel is provided, which extends coaxially around the shielding gas channel, so that the shielding gas channel and extraction channel are aligned centrally to one another.

In an advantageous development of the invention, the extraction device comprises a plurality of extraction openings for the flue gas, preferably evenly distributed on the circumference of the torch neck. The extraction openings can be disposed at approximately the same distance from one another, wherein each extraction opening is fluidly connected to the extraction device via the extraction channel. In this way, the flue gas is extracted evenly. Preferably, an even number of extraction openings can be provided in order to be able to produce the nozzle using a mold.

According to a further variant, the torch-side end of the shielding gas channel is connected via a shoulder to the at least one extraction channel disposed radially and offset in the axial direction.

The shielding gas channel is formed by a preferably approximately cylindrical nozzle section with an inner and outer surface, wherein the shielding gas is conducted inside the nozzle section. The torch-side end of the shielding gas channel, in particular the outer surface of the nozzle section forming the shielding gas channel, opens into the shoulder, which can preferably protrude outward in relation to the nozzle section. This shoulder is connected to the extraction channel, wherein the extraction openings are disposed in the region of the shoulder, which preferably extends obliquely. Due to the obliquely extending shoulder, the flue gases and pollutants are extracted over a larger extraction region. Because of the inclination, the extraction opening(s) is/are oriented not only in the direction of flow, but also in the direction laterally of the nozzle, so that, as a result, the extraction region is enlarged, in particular compared to a non-oblique shoulder extraction opening.

In addition, the extraction openings, which are oriented forward and additionally outward, are particularly important for the extraction of ozone as a gaseous pollutant. This is because the ozone is only produced at some distance from the welding process, induced by the arc radiation. Overall, a greater degree of freedom is advantageously achieved by arranging the extraction openings further rearward and facing outward.

In particular, the torch-side end of the shielding gas channel can be connected integrally to the extraction channel via the shoulder. In this way, the use of the welding torch with a nozzle according to the invention is only possible when the nozzle with an extraction region is installed. Due to this safety feature, the user is optimally protected from flue gases and pollutants.

In a further development of the invention, it is provided that the extraction openings have an elliptical or oval-shaped cross-section.

In particular, in the event that the extraction openings extend over the oblique shoulder, it can be provided that the extraction openings have an elliptical or oval-shaped cross-section in relation to the surface of the shoulder. In this way, the extraction region for the flue gases and pollutants is further increased, which is particularly relevant for gases such as ozone. Furthermore, the extraction openings can be easily created, in terms of manufacturing, by drilling.

According to the invention, it is provided that the nozzle comprises a threaded insert for screwing onto a torch neck. This ensures easy installation and interchangeability of the nozzle on the torch.

It is particularly advantageous that, according to the invention, an electrical insulation, in particular an injection material, is provided between the threaded insert and the extraction device. The insulation material can be processed by molding, transfer molding, or injection molding. Preferably, an insulation made of phenolic molding compound filled with glass fibers and minerals is used. This material offers very high mechanical stability in all directions while at the same time offers very good electrical insulation properties.

According to an advantageous development of the invention, the threaded insert can be pressed into a receptacle of the nozzle; in particular, the threaded insert can be pressed into a spray compound for electrical insulation located in the receptacle of the nozzle. This is particularly advantageous because the assembly of the nozzle is further simplified.

In a further advantageous variant of the invention, as an alternative to the embodiment in which the torch-side end of the shielding gas channel is connected integrally to the extraction channel via the shoulder, it can be provided that the extraction device with the extraction channel and extraction openings is detachably disposed on a sub-element of the combined extraction/shielding gas nozzle, wherein the sub-element comprises the shielding gas channel with shielding gas outlet openings. The threaded insert for screwing onto the torch neck and/or the electrical insulation can also be provided in this sub-element. In particular, it is conceivable that the sub-element and the extraction device are screwed together. For this purpose, the sub-element can have an outer threading, onto which the extraction device can be screwed with a corresponding inner threading.

According to an advantageous embodiment of the invention, it is provided that the extraction/shielding gas nozzle comprises a receiving region at the front end, in particular in the region of the shielding gas outlet opening, for receiving, in particular for attaching or screwing on, a disposable cap, and preferably that the receiving region comprises an outer threading for screwing on the disposable cap with a corresponding inner threading.

This disposable cap has the advantage that it can be manufactured geometrically very simply and therefore inexpensively. The highest loads with respect to the arc-induced heat input and also spatter thus impact this component and not the more complex shielding gas extraction nozzle. The service life of the combined shielding gas extraction nozzle can be at least one order of magnitude longer than the service life of the disposable cap. A further advantage is that the geometry, preferably the length, of the disposable cap can be easily adjusted, or a user can adjust this themselves.

According to an advantageous development of the invention, the extraction device is made of aluminum, in particular of an aluminum alloy, and/or the threaded insert is made of brass and/or the disposable cap is made of copper. The specific advantages of aluminum are its low density, good machinability, and good thermal conductivity. The advantages of brass are its good thermal conductivity and high hardness, so that the threading does not wear out. The advantages of copper are its very good thermal conductivity, which significantly reduces spatter adhesion.

An independent concept of the invention relates to a torch neck for thermally joining at least one workpiece, in particular for arc welding, with a previously described combined extraction/shielding gas nozzle.

According to an advantageous development of the invention, an extraction tube channel for extracting the flue gas is fluidly connected to the extraction device of the extraction/shielding gas nozzle.

It is conceivable that the extraction tube channel is part of a handle for the torch, in particular that the handle is formed from two half-shells.

The invention further relates to a torch with a previously described torch neck.

Further objectives, advantages, features, and applications of the present invention are derived from the subsequent description of an embodiment by way of the drawings. All described and/or depicted features per se or in any combination constitute the subject-matter of the present invention, regardless of their summary in the patent claims or their back-reference.

### DESCRIPTION OF THE DRAWINGS

Partially schematically, the drawings show:

FIG. 1 a perspective view of a combined extraction/shielding gas nozzle,

FIG. 2 a sectional view of the nozzle according to FIG. 1,

FIG. 3 a further sectional view of the nozzle according to FIG. 1,

FIG. 4 a perspective view of the combined extraction/shielding gas nozzle according to FIG. 1 with a disposable cap,

FIG. 5 a sectional view of the nozzle according to FIG. 4,

FIG. 6 a further sectional view of the nozzle according to FIG. 4,

FIG. 7 a perspective view of the portion of a torch with a combined extraction/shielding gas nozzle and disposable cap, and

FIG. 8 a sectional view of the torch according to FIG. 7.

### DETAILED DESCRIPTION

Identical or identically functioning components are provided with reference numerals based on an embodiment in the subsequently depicted figures of the illustration in order to improve readability.

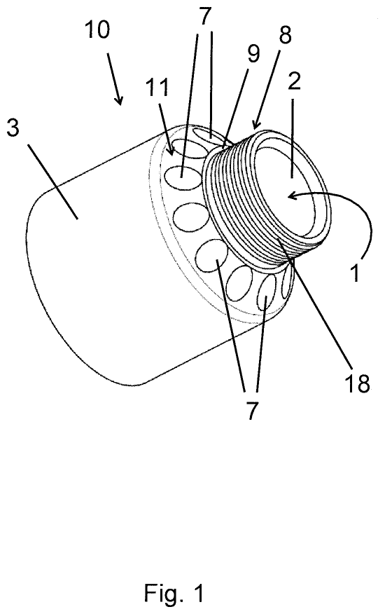

FIG. 1 shows a combined extraction/shielding gas nozzle 10 for an arc welding torch with a consumable electrode, in particular a MIG torch.

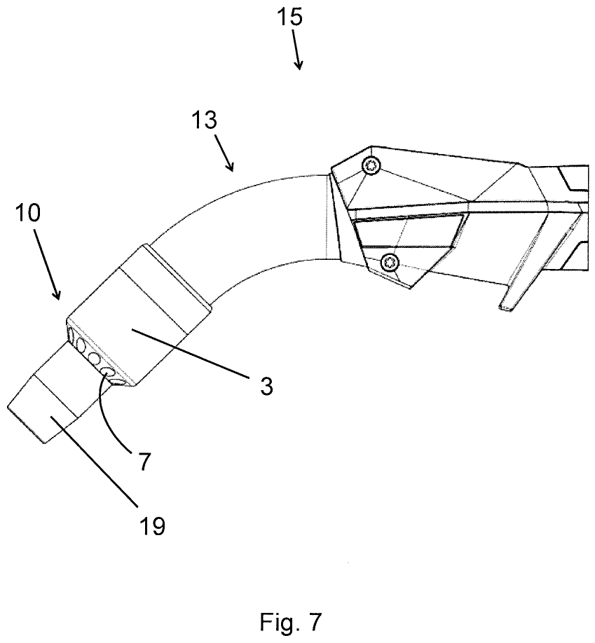

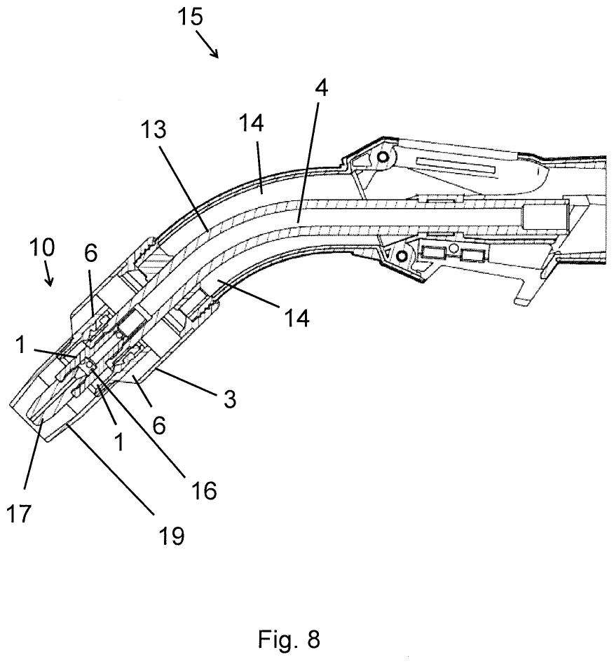

This extraction/shielding gas nozzle 10 is disposed, in particular screwed, on a torch neck 13 (not shown in FIG. 1) of a welding torch 15. Such a torch neck 13 is shown in FIGS. 7 and 8.

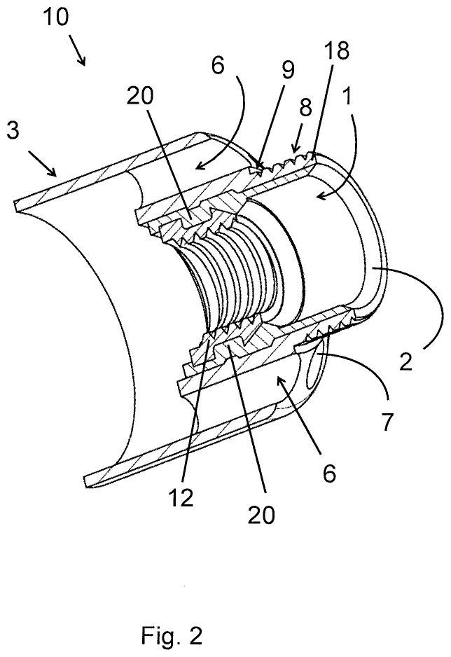

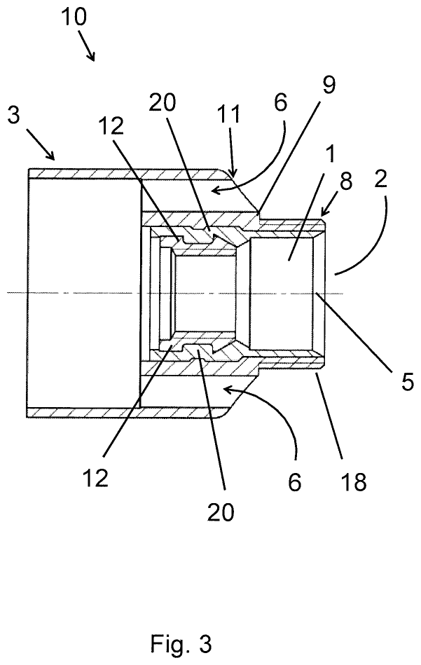

As can be seen in particular from the sectional views according to FIGS. 2 and 3, which show the embodiment according to FIG. 1, the extraction/shielding gas nozzle 10 comprises a shielding gas channel 1 with a shielding gas outlet opening 2 for supplying shielding gas to the welding process. In the present embodiment, the shielding gas channel 1 is conducted approximately centrally in the extraction/shielding gas nozzle 10.

The sectional view of the torch 15 with the torch neck 13 in FIG. 8 shows a shielding gas inlet channel 4 for introducing the shielding gas through the torch neck 13 into the combined extraction/shielding gas nozzle 10. There, the shielding gas enters the shielding gas channel 1 from the shielding gas inlet openings 16 and exits the nozzle 10 through the shielding gas outlet opening 2 to the welding process.

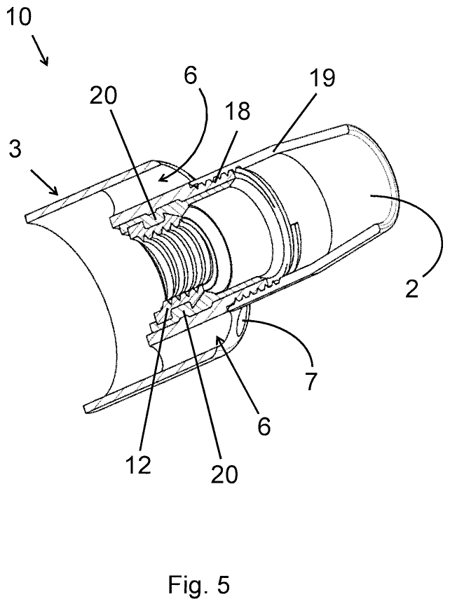

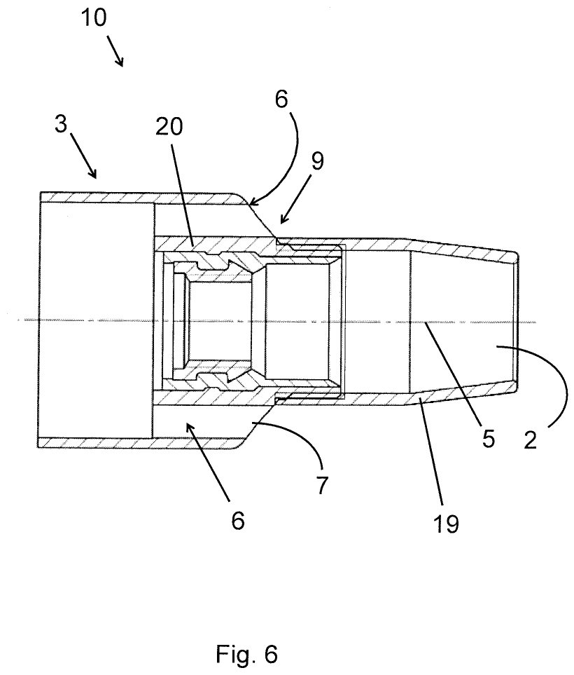

Furthermore, the extraction/shielding gas nozzle 10 comprises an extraction device 3 for extracting the flue gas and pollutants that are produced during the welding process. In the present case, a plurality of extraction openings 7 evenly distributed around the circumference of the torch neck 13 are provided for the flue gas. These extraction openings 7 are fluidly connected to at least one extraction channel 6, as illustrated by FIGS. 1 to 8. In the present exemplary embodiment, the extraction device 3 comprises a plurality of extraction channels 6, each having one extraction opening 7, which are evenly distributed around the circumference of the torch neck 13. An extraction tube channel 14 for extracting the flue gas is fluidly connected to the extraction device 3 of the shielding gas nozzle 10.

In the present case, the extraction openings 7 have an elliptical or oval-shaped cross-section, and the main axis of the elliptical or oval-shaped cross-section extends approximately parallel to the longitudinal axis 5 of the nozzle 10.

FIGS. 1 to 6 show that the shielding gas channel 1 is formed by a preferably approximately cylindrical nozzle section with an inner and outer surface, wherein the shielding gas is conducted inside the nozzle section. The torch-side/rear end 9 of the shielding gas channel 1, in particular the outer surface of the nozzle section forming the shielding gas channel 1, opens into the shoulder 11, which can preferably protrude outward in relation to the nozzle section.

This shoulder 11 is connected to the extraction channel 6, wherein the extraction openings 7 are disposed in the region of the shoulder 11, which extends obliquely here. These extraction channels 6 with extraction openings 7, which are oriented forward and additionally outward, are particularly important for the extraction of ozone as a gaseous pollutant.

In particular, the torch-side end 9 of the shielding gas channel 1 can be connected integrally to the extraction channels 6 via the shoulder 11.

As can further be seen from FIGS. 2 and 3, the extraction channels 6 with extraction openings 7 of the extraction device 3 are disposed axially offset from the shielding gas outlet opening 2 of the nozzle 10 in relation to the longitudinal axis 5 of the nozzle. Moreover, the shielding gas channel 1 and the at least one extraction channel 6 are disposed radially and offset to one another in the axial direction such that the extraction openings 7 for the extraction channels 6 lie behind the shielding gas channel 1 in the direction of flow of the flue gas. The shielding gas channel 1 and the extraction channels 6 are aligned substantially axially parallel to one another.

In other words, the extraction openings 7 are rearwardly offset in relation to the gas outlet 2 for the shielding gas in the flow direction of the flue gas and offset radially outward, so that these extraction openings 7 are spaced apart from the welding process.

The flue gas or pollutants produced in the welding process are sucked into the extraction channels 6 through the extraction openings 7.

This orientation (outward and less forward) is particularly important for the extraction of ozone as a gaseous pollutant, which is only created at some distance from the process, induced by the arc radiation. Especially in aluminum applications, a high ozone concentration can arise from the arc radiation even at low powers. Here, the invention creates a greater degree of freedom in that the extraction section, i.e., the extraction openings 7, are disposed further rearward and aligned outward.

The extraction of the flue gas and the supply of the shielding gas take place one after the other in the flow direction, i.e., shielding gas flows out at the front end of the nozzle and the extraction only takes place behind it, when viewed in the flue gas extraction direction. This largely prevents the shielding gas from being heated by hot flue gases.

FIGS. 7 and 8 further illustrate that these flue gases and pollutants are extracted through an extraction tube channel 14 disposed in a handle of the torch 15.

FIGS. 7 and 8 show a portion of the welding torch 15 with a power contact nozzle 17 and a torch neck 13 with a combined extraction/shielding gas nozzle 10. In particular from FIG. 8, it can be seen that an extraction tube channel 14 for extracting the flue gas is fluidly connected to the extraction device 3 of the shielding gas nozzle 10. The extraction tube channel 14 is a part of a handle for the torch 15, which in the present case is formed from two half-shells.

As can be seen from FIGS. 7 and 8, the nozzle 10 is disposed on the torch neck 13 for thermally joining at least one workpiece, in particular for arc welding. For this purpose, the nozzle 10 in the present exemplary embodiment comprises a threaded insert 12 for screwing onto the torch neck 13.

In the present case, the threaded insert 12 is pressed into a molding material or injection material 20 disposed in the receptacle of the nozzle 10 for electrical insulation between the torch neck 13 and the nozzle 10, as can be seen from FIGS. 7 and 8. The insulation material can be processed by molding, transfer molding, or injection molding. Preferably, an insulation made of phenolic molding compound filled with glass fibers and minerals is used.

In the exemplary embodiment described here, the torch-side end 9 of the shielding gas channel 1 is connected integrally to the extraction channels 6 via the shoulder 11, i.e., a use of the welding torch 15 is only possible in a combination of the combined extraction/shielding gas nozzle 10 with the extraction device 3.

According to an exemplary embodiment (not shown), it can be provided as an alternative to this embodiment that the extraction device 3 with the extraction channels 6 and extraction openings 7 is detachably disposed on a sub-element of the combined extraction/shielding gas nozzle 10, wherein the sub-element comprises the shielding gas channel 1 with shielding gas outlet openings 2. The threaded insert 12 for screwing onto the torch neck 13 and/or the electrical insulation 20 can also be provided in this sub-element. In particular, it is conceivable that the sub-element and the extraction device 3 are screwed together. For this purpose, the sub-element can have an outer threading, onto which the extraction device 3 can be screwed with a corresponding inner threading.

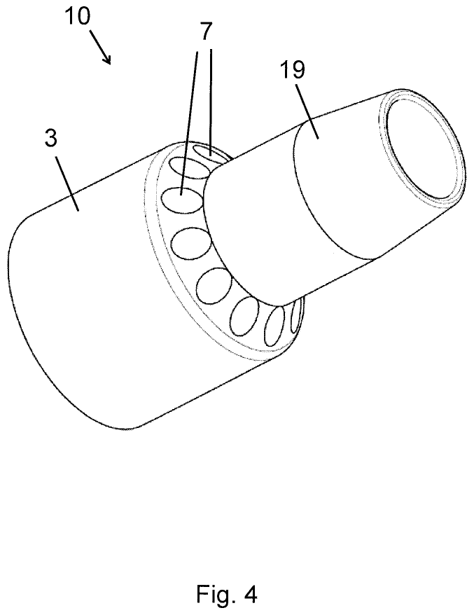

As can be seen in particular from FIGS. 4, 5, and 6, a receiving region for receiving a disposable cap 19 is provided at the front end 8 of the nozzle 10 in the region of the shielding gas outlet opening 2. This disposable cap 19 can be attached to the nozzle 10. According to FIGS. 4-6, it is also conceivable that the disposable cap 19 is screwed onto a corresponding outer threading 18 of the nozzle 10 with an inner threading. The highest loads with respect to the arc-induced heat input and also spatter thus impact the disposable cap 19 and not the more complex shielding gas extraction nozzle 10. The service life of the combined shielding gas extraction nozzle 10 can be at least one order of magnitude longer than the service life of the disposable cap 19.

The extraction device 3 substantially consists of aluminum, in particular an aluminum alloy. The threaded insert 12 preferably consists of brass, and the disposable cap 19 can consist of copper.

### REFERENCE NUMERALS

1 Shielding gas channel
2 Shielding gas outlet opening
3 Extraction device
4 Shielding gas inlet channel
5 Longitudinal axis of nozzle
6 Extraction channel
7 Extraction openings
8 Front end of shielding gas channel
9 Rear/torch-side end of shielding gas channel
10 Combined extraction/shielding gas nozzle
11 Shoulder
12 Threaded insert
13 Torch neck
14 Extraction tube channel
15 Torch
16 Shielding gas inlet opening
17 Power contact nozzle
18 Outer threading of nozzle—Disposable cap
19 Disposable cap
20 Electrical insulation/molding material

1. A combined extraction/shielding gas nozzle (10) of an arc welding torch with a consumable electrode, comprising:
a shielding gas channel (1) for supplying shielding gas to a welding process;
an extraction device (3) with at least one extraction channel (6) with an extraction opening (7) for extracting the flue gas produced during the welding process, wherein the shielding gas channel (1) and the at least one extraction channel (6) are disposed radially and offset to one another in the axial direction such that the extraction opening (7) for the at least one extraction channel (6) lies behind the shielding gas channel (1) in the direction of flow of the flue gas,
a threaded insert (12) for screwing onto a torch neck (13) of a welding torch (15); and
an electrical insulation (20) between the threaded insert (12) and the extraction device (3).

2. The nozzle (10) according to claim 1,
wherein the shielding gas channel (1) and the extraction channel (6) are aligned substantially axially parallel to one another.

3. The nozzle (10) according to claim 1, wherein the extraction device (3) comprises a plurality of extraction openings (7) for the flue gas, which are disposed on the circumference of the torch neck (13).

4. The nozzle (10) according to claim 1, wherein the shielding gas channel (1) has a torch-side end (9), and the torch-side end (9) of the shielding gas channel (1) is connected via a shoulder (11) to the at least one extraction channel (6) disposed radially and offset in the axial direction.

5. The nozzle (10) according to claim 4, wherein the extraction openings (7) are disposed in the shoulder (11).

6. The nozzle (10) according to claim 4, wherein the torch-side end (9) of the shielding gas channel (1) is connected integrally via the shoulder (11) to the at least one extraction channel (6).

7. The nozzle (10) according to claim 1, wherein the extraction openings (7) have an elliptical or oval-shaped cross-section.

8. The nozzle (10) according to claim 1, further comprising a molding material or injection material is provided between the threaded insert (12) and the extraction device (3).

9. The nozzle (10) according to claim 1, wherein the threaded insert (12) is pressed into a receptacle of the nozzle (10).

10. The nozzle (10) according to claim 9, wherein the threaded insert (12) is pressed into molding material or injection material (20) disposed in a receptacle of the nozzle (10) for electrical insulation.

11. The nozzle (10) according to claim 1, wherein the extraction device (3) is disposed detachably on the shielding gas channel (1).

12. The nozzle (10) according to claim 11, wherein the extraction device (3) and the shielding gas channel (1) are detachably joined together by a screw connection.

13. The nozzle (10) according to claim 1, further comprising a disposable cap (19) that is configured for detachable attachment to a front end (8) in the region of the shielding gas outlet opening (2).

14. The nozzle (10) according to claim 13, wherein the receiving region comprises an outer threading (18) for screw connection with the disposable cap (19) that comprises a corresponding inner threading.

15. The nozzle (10) according to claim 1, wherein the extraction device (3) comprises aluminum or an aluminum alloy, and wherein the threaded insert (12) comprises brass, and wherein the disposable cap (19) comprises copper.

16. A torch neck (13) of a welding torch for thermally joining at least one workpiece in combination with a combined extraction/shielding gas nozzle (10) according to claim 1.

17. The torch neck (13) according to claim 16, further comprising an extraction tube channel (14) for extracting the flue gas fluidly connected to the extraction device (3) of the shielding gas nozzle (10).

18. A welding torch (15) comprising a torch neck (13), and further comprising a combined extraction/shielding gas nozzle (10) according to claim 1 detachably joined to the torch neck (13).
